(19) United States
(12) Patent Application Publication
(10) Pub. No.: US 2015/0283709 A1
(43) Pub. Date: Oct. 8, 2015

(54) Industrial Robot Arm

(71) Applicant: Sergei Dalakian, Mercer Island, WA (US)

(72) Inventor: Sergei Dalakian, Mercer Island, WA (US)

(21) Appl. No.: 14/247,342

(22) Filed: Apr. 8, 2014

(51) Int. Cl. B25J 17/02

(52) U.S. Cl. CPC B25J 17/025

(57) ABSTRACT

An articulated robot arm or the like comprising a base, an upper section which is pivotally secured to the base at a shoulder joint, one or more middle sections pivotally secured to the upper section at an elbow joint, a lower section pivotally secured to the middle section at an wrist joint and a final section pivotally secured to the lower section. A main arm folding apparatus comprising an upper timing linkage, one or more middle timing linkages and lower timing linkage. The first lead gear of the main arm folding apparatus is fixed to the main drive pivot coaxial with the shoulder joint, the last slave gear of the arm folding apparatus is fixed to the final section. None of the other sections is fixed to the arm folding apparatus. That allows the arm to adapt its shape while folding around an object thus distributing pressure along its surface. The integration of the supplementary arm folding apparatus, similar to the main arm folding apparatus and linking said final section with the supplemental drive pivot coaxial with said shoulder joint, allows implementation of the controlled stiffness via internal preloading of the arm. Each timing linkage could be implemented as a set of sprockets linked by chain (or timing belt) or gears linked via a parasite gear. Coordinated operation of a system comprising two or more robot arms allows manipulation of large fragile objects.

### BACKGROUND OF THE INVENTION

The present invention related to robot arms, and particularly to articulated robot arms which are used industrially in automated manufacturing operations and the like.

Articulated robot arms are used in industry to perform two major operations:
Moving a tool along a desired trajectory (welding, cutting, painting);
Manipulating object's position and orientation (placing objects on a conveyor in a certain orientation, assembling parts and the like).
   (Movements of all sections of an articulated arm must be coordinated with respect to each other in order to provide the desired movement of the final section.)

Each section of an articulated arm must move in a well-defined way, in relation to the other sections of the arm. Such precision is required to move the terminal segment, or final section, of the arm in the directions and to the positions which are necessary to carry out the intended function.

In most articulated arms each section requires it own drive and a programmable control system to operate the drives in coordination. The main disadvantage of these arms—the section-mounted drives are located at a distance from its base. These drives thus are cantilevered a substantial distance from the base when the arm is extended horizontally. Even in space applications, where weight is not an issue, a massive drives spinning around remote axle cause the inertia problems. A much more complicated wire harnesses also make the system more complicated and less reliable.

An alternative to a robot arm with fully independent drives for each section is one with mechanically linkages, such as parallelogram or “pantograph” linkages. These linkages join two or more adjacent sections of the arm so when one section is driven the next section moves in a complementary manner. That approach allows mounting of the drives closer to the base, however all movements of sections are predetermined by a specific mechanical linkage thus making impossible adaptation of arm's behavior to a specific environment—say, shape of the object of manipulation. That leads to excessive local surface pressure and might cause damage of fragile objects, for instance, an Aluminum barrel.

### SUMMARY OF THE INVENTION

One object of the invention is a folding multi-section robotic arm, having at least three sections extending in series from a base, which overall shape and behavior depend on the environment thus allowing instant mechanical (non-programmable) adaptation to both shape and size of the object, as well as surrounding objects.

Another object of the invention is a folding multi-section robotic arm having two similar but independent linkages allowing internal preloading of the arm, thus implementing an operator-controlled shape and stiffness of the arm, as well as determination of the way of arm's folding (sequence of sections movements).

Yet another object of the invention is a combination of two or more similar arms acting in co-ordinance as one robotic system, capable of grabbing an object of spherical shape.

Other objects of the invention will become apparent to one of ordinary skill in the art in light of the present specification, drawings and claims.

The present invention is a robot arm or the like comprising a base, an upper section, one or more middle sections, a lower section and final section (“fingernail”), a main arm folding apparatus comprising timing linkages (based on chain-and-sprocket sets or timing belt-and-pulley sets). The base can be fixed to a stationary, pivoting or mobile support. The first end of the upper section is secured to the base by the shoulder pivot to define a shoulder joint. The first end of the middle section is secured to the second end of the upper section by the elbow pivot to define an elbow joint. The first end of the lower section is secured to the second end of the middle section by the wrist pivot to define a wrist joint.

The main arm folding apparatus has the upper timing linkage, the middle timing linkage and the lower timing linkage. Each of those timing linkages comprises a lead and follower disks rotatably mounted on the two neighboring pivots related to a given section- shoulder, elbow or wrist pivots.

The arm can include the secondary arm folding apparatus, similar to the main arm folding apparatus, having its own independent drive and enabling internal preloading of the arm.

### BRIEF DESCRIPTION OF DRAWINGS

FIG. 1 is a side elevational view of a robot arm according to one embodiment of the present invention.

FIG. 2 is a top plan view of the arm of FIG. 1

FIG. 3 is a top plan view of an alternate, asymmetric embodiment of the invention

FIG. 4 is a sectional view of the arm taken along line 60-60 of FIG. 2, showing the chain-and-sprocket based folding mechanism

FIG. 5 is a sectional view of the arm taken along line 30-30 of FIG. 2, showing an alternate parasite-gear based folding mechanism

FIG. 6 is a kinematic diagram of the robotic arms of FIG. 1 and FIG. 2 with a single arm folding mechanism and drive

FIG. 7 is a kinematic diagram of the robotic arms of FIG. 1 and FIG. 2 with two arm folding mechanisms and drives

FIG. 8 WITHDRAWN (According to Examiner recommendation)

(sectional view of the arm taken along line 70-70 of FIG. 1 showing the construction of its shoulder-mounted planetary drive unit)

FIG. 9 is a view similar to FIG. 1 showing the arm folding around an object from the initial vertical position (shown in phantom lines) to the middle position (shown in full lines).

FIG. 10 is a view similar to FIG. 1 showing the arm folding around an object from the middle position (shown in phantom lines) to the final position (full lines).

### DETAILED DESCRIPTION OF THE INVENTION

While the invention will be described in connection with one or more preferred embodiments, it will be understood that the invention is not limited to those embodiments. On the contrary, the invention includes all alternatives, modifications and equivalents as may be included within the spirit and scope of the appended claims. Like or corresponding parts of the respective views are indicated by like reference characters.

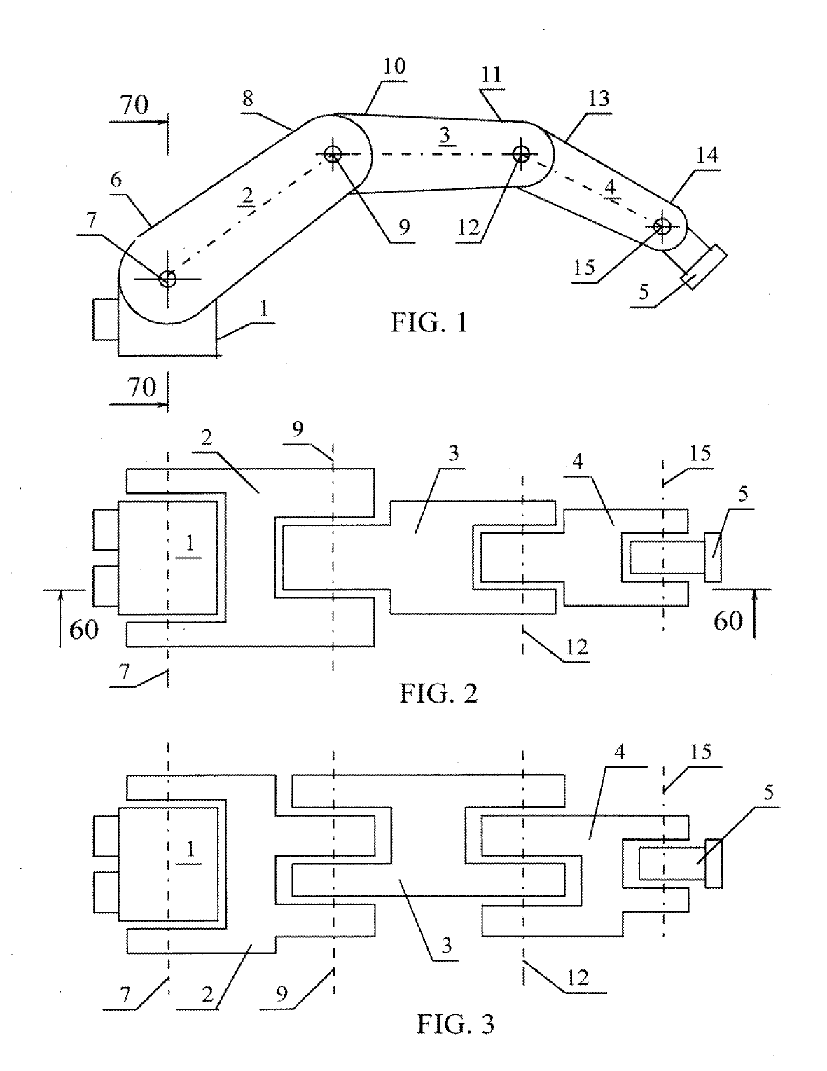

Referring now the drawings and particularly the FIG. 1 and FIG. 2, the robot arm comprises a base 1, an upper section 2, a middle section 3, a lower section 4 and final section 5. The upper section 2 has a first end 6 secured to the base 1 by a shoulder pivot 7 for rotation about a horizontal axis to define a shoulder joint permitting rotation of the upper section 2 in a vertical plane. If any additional movement of the robotic arm is also desired, the base 1 can be positioned on a turret or other apparatus allowing such movement.

The second end 8 of the upper section 2 is connected by the elbow pivot 9 to the first end 10 of the middle section 3. In this embodiment the axis of the pivot 9 is also horizontal, so the middle section 3 also rotates about its pivot 9 in a vertical plane. The second end 11 of the middle section 3 is connected by a wrist pivot 12 to the first end 13 of the lower section 4. In this embodiment, the pivot 12 also permits rotation about a horizontal axis, in a vertical plane. The second end 14 of the lower section 4 is connected by a final pivot 15 to the final section 5. In this embodiment, the pivot 15 also permits rotation about a horizontal axis, in a vertical plane.

In the embodiment of FIG. 2, the upper section 2, middle section 3, lower section 4 and final section 5 are all symmetrically centered on a common vertical plane. The second end 8 of the upper section 2 defines a fork which receives the first end 10 of the middle section 3. A comparable structure is used to join the second end 11 of middle section 3 to the first end 13 of the lower section 4, as well as the second end 14 of the lower section 4 to the final section 5.

There might be numerous alternate (offset, asymmetric) arrangements of sections, like one shown in FIG. 3. In spite of different appearance, this asymmetric arm functions equivalently to the embodiment illustrated in FIG. 2.

Either embodiment of the arm has shoulder, one or more elbows and wrist joints joining a base, upper section, one or more middle sections, lower section and final section (“finger nail”), analogous to the structure of the human arm and hand.

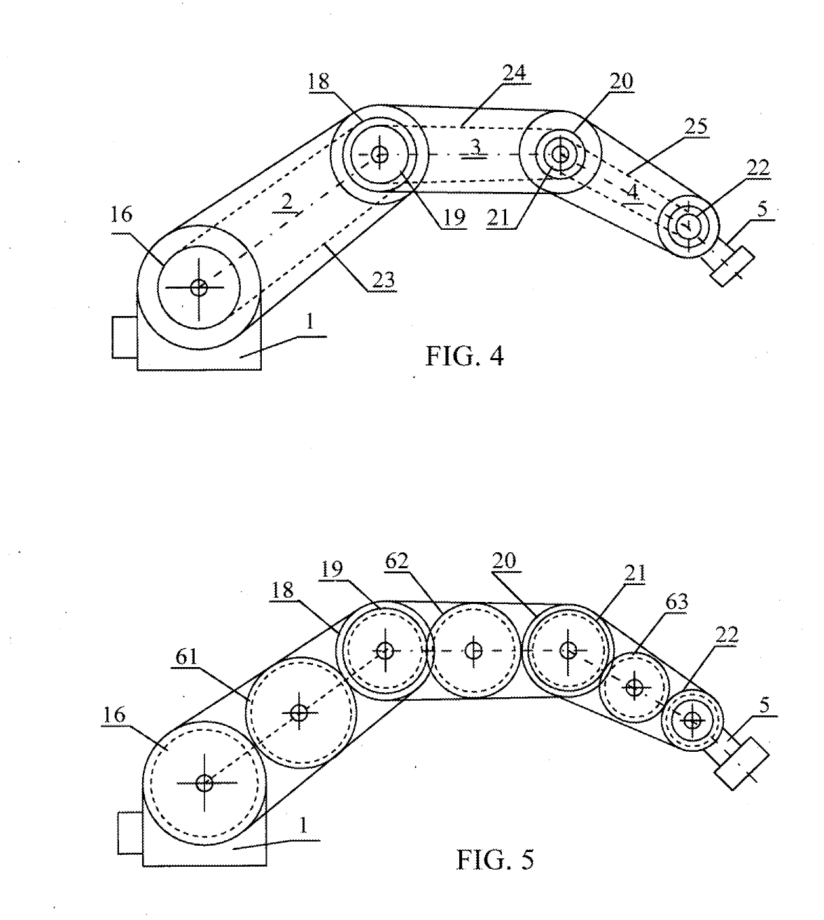

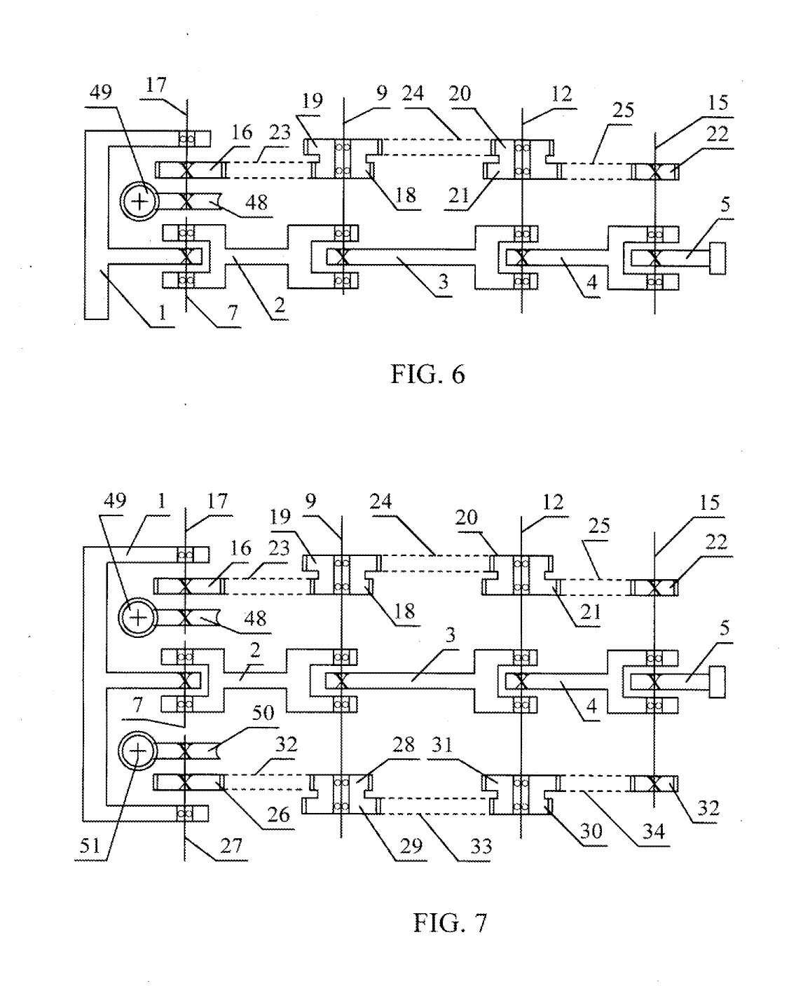

The mechanism for folding and unfolding the arm will now be described schematically, with reference to FIG. 4, FIG. 5, FIG. 6 and FIG. 7.

Referring first to FIG. 6, a kinematic diagram of the robotic arm with a single arm folding apparatus is illustrated.

A main arm folding apparatus comprises: an upper timing linkage, a middle timing linkage, a lower timing linkage. The expression “timing linkage” means an apparatus providing timing linkage between a lead and slave disks. That means any fractional pivoting of the lead disk causes appropriate pivoting of the slave disk multiplied by ratio. The ratio number could range from 1:1 to 1:5 or more—depending on application. Most common implementations of a timing linkage: a timing belt or chain linking a lead and slave pulleys, or a parasite gear linking a lead and slave gears. The timing link between a lead and slave disks could even be materialized by electronic means like a set of lead and slave servomotors linked via a programmable controller providing their synchronized operation.

For clarification, a kinematic diagram at FIG. 6 shows timing linkages based on sprockets linked by chain.

An upper chain-and-sprocket linkage having a lead sprocket 16 which is rotatably secured to said base by first drive pivot 17 coaxial with said shoulder pivot 7, a slave sprocket 18 mounted in coaxial relation to said elbow pivot 9 and freely rotatable with respect to said upper section 2 and lower section 3.

A middle chain-and-sprocket linkage having a lead sprocket 19 which is rotatably secured to said elbow pivot 9 while being fixed to said slave sprocket 18, a slave sprocket 20 rotatably secured to said wrist pivot 12;

A lower chain-and-sprocket linkage having a lead sprocket 21 which is rotatably secured to said wrist pivot 12 while being fixed to said slave sprocket 20, a final sprocket 22 mounted in coaxial relation to said final pivot 15 and fixed to final section 5;

An upper drive chain 23 operatively connecting said lead sprocket 16 and slave sprocket 18. A middle drive chain 24 operatively connecting said lead sprocket 19 and slave sprocket 20. A lower drive chain 25 operatively connecting said lead sprocket 21 and slave sprocket 22.

FIG. 4 illustrates an embodiment of the robotic arm according to the kinematic diagram shown at FIG. 6, where the chains 23, 24 and 25 are used to provide timing linkage between the lead and slave sprockets 16 and 18, 19 and 20, 21 and 22 accordingly.

The number of teeth of all lead and slave sprockets doesn't play a decisive role in operation of the arm. When minimization of the arm's cost is an issue, all sprockets (or gears) could be identical, having equal number of teeth. More practical would be an implementation where each slave sprocket has one or two teeth less that its mating lead sprocket thus allowing to reduce the size of each consecutive section. However the positive or negative ratios do have some impact. For an arm with a single arm folding apparatus the ratios define the distribution of pressure along object's surface. In implementations with a dual arm folding apparatus (allowing internal preloading), the ratios also define the way the sections are folding.

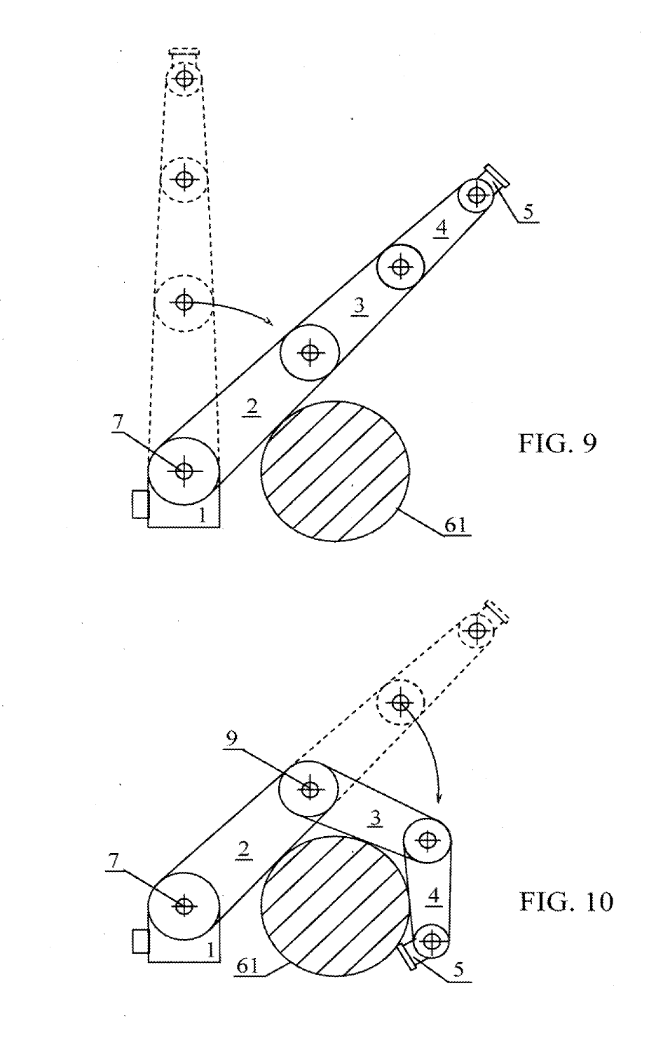

It is important to note that in various possible embodiments of the present invention all sections of the robotic arm, with exception of the final section, are not fixed to any particular part of the arm folding apparatuses, thus their behavior (movements) is not easily defined since it depends on surrounding environment and internal pre-loading. FIG. 9 and FIG. 10 help visualize the interaction of the robotic arm with a round-shaped object 61.

### Operation of the Arm Folding Apparatus

Pivoting of the worm 49 by a rotary motor (not shown) causes appropriate pivoting of the worm gear 48 and lead gear 16. Up to this point the mechanism behaves according to basic rules of classic mechanic. However a further movement is not easily defined since it splits depending on many factors. A mechanical combination of said section 2 and slave gear 18 does in fact represent a device similar to a satellite carrier in a planetary reducer: the rotary movement of slave gear 16 (in planetary terms acting as a “sun gear”) could lead to pivoting of section 2 around said shoulder pivot 7 (acting as a “satellite carrier”) or pivoting of said slave gear 18 (acting as “satellite”) around said elbow pivot 9.

Gravity plays a major role in defining which movement would prevail. A substantial negative gear ratio (over 1:2) also increases the likelihood of section 2 movement. FIG. 9 illustrates rotation of said section 2 around said shoulder pivot 7 from its initial position (phantom lines) until a contact with an object 61 makes further movement impossible. After that any further pivoting of said lead gear 16 could only lead to pivoting of said slave gear 18 and lead gear 19.

A kinematic link between the lead gear 16 and slave gear 18 could be implemented via chain 23 (FIG. 4) or parasite gear 61 (FIG. 5). In both implementations said chain 23 or parasite gear 61 play no role other that transmitting the movement.

FIG. 5 illustrates an alternative embodiment where the lead and slave gears are used instead of the lead and slave sprockets, and parasite gears provide link between them. Since all gears and sprockets are in fact similar timing disks (a different tooth profile plays no significant role in their function), all lead and slave gears at FIG. 5 have the same location, functions and numbering as the lead and slave sprockets at FIG. 4 and FIG. 6.

In the gear-based embodiment (FIG. 5) an upper parasite gear 61 operatively connecting said lead gear 16 and slave gear 18. A middle parasite gear 62 operatively connecting said lead gear 19 and slave gear 20. A parasite gear 63 operatively connecting said lead gear 21 and slave gear 22.

In numerous possible embodiments of the current invention the drive chains and sprockets can be replaced by equivalent timing means such as belts and sheaves, timing belts and timing pulleys, gear trains, or the like without departing from the spirit of the invention. Chains are preferred because they do not slip or stretch, they are more wear-resistant than belts and they are lighter than gear trains. In an alternate embodiment of the invention, the so-called “electronic gearing” might be implemented. In that case each sprocket could have its own independent drive and a computer provides the synchronization of all movements, emulating the real gear mesh.

In another alternative embodiment of the invention one or more chains could be replaced by a combination of rigid links and one or all the sprockets could each be replaced by a crank, while the crank corresponding to the first sprocket would be fixed to the first drive, the crank corresponding to the final sprocket would be fixed to the final section.

The first drive means for folding and unfolding said arm in the embodiment of FIG. 6 is represented by a worm gear 48 providing pivoting of said first drive pivot 17 about said shoulder pivot 7 with respect to said base 1. Said worm gear 48 is meshed with a worm 49 powered by any rotary drive (electric, hydraulic or pneumatic motor, not shown).

FIG. 7 shows a kinematic diagram of a robotic arm with dual arm folding apparatus, where a supplemental arm folding apparatus is being added to the main arm folding apparatus illustrated on FIG. 6.

A supplemental arm folding apparatus is similar to the main arm folding apparatus, but fulfills its own separate function—internal preloading of the robotic arm. That allows to control the overall stiffness of the arm. The supplemental arm folding apparatus is kinematically independent and generally has its own drive means. It also comprises a supplemental upper timing linkage, a middle timing linkage and lower timing linkage.

A supplemental upper timing linkage at FIG. 7 is represented by a lead sprocket 26 which is rotatably secured to said base by second drive pivot 27 coaxial with said shoulder pivot 7, a slave sprocket 28 mounted in coaxial relation to said elbow pivot 9 and freely rotatable with respect to said upper section 2 and lower section 3.

A supplemental middle timing linkage having a lead sprocket 29 which is rotatably secured to said elbow pivot 9 while being fixed to said sprocket 28, a slave sprocket 30 rotatably secured to said wrist pivot 12;

A supplemental lower chain and-sprocket linkage having a lead sprocket 3 1 which is rotatably secured to said wrist pivot 12 while being fixed to said sprocket 30, a final sprocket 32 mounted in coaxial relation to said final pivot 15 and fixed to final section 5;

A supplemental upper drive chain 32 operatively connecting said lead sprocket 26 and slave sprocket 28. A supplemental middle drive chain 33 operatively connecting said lead sprocket 29 and slave sprocket 30. A supplemental lower drive chain 34 operatively connecting said lead sprocket 31 and slave sprocket 32.

The supplemental drive means of said supplemental arm folding apparatus are represented by a worm gear 50 providing pivoting of said second drive pivot 27 about said shoulder pivot 7 with respect to said base 1. Said worm gear 50 is meshed with a worm 51 powered by any rotary drive (electric, hydraulic or pneumatic motor, not shown).

The supplemental arm folding apparatus provides the internal pre-loading of robotic arm by applying torques in direction opposite to the main arm folding apparatus. There is similar to a human arm: the muscles pulling bones in opposite directions cause an overall stiffness of the arm.

The initial internal preloading plays a very important role in operation of the robotic arm with dual arm folding apparatus. Initially, while said worm 49 is still immovable, said worm 51 performs a limited rotation until all slacks in both power trains (the main and supplemental arm folding apparatus) are completely eliminated. An additional discrete rotation of said worm 51 will create the internal preloading—proportional to the degree of this rotation. After that initial phase both worms 49 and 51 perform synchronous rotation in the same direction. That would force all the lead and slave gears of the supplemental arm folding apparatus to rotate synchronously with their appropriate counterparts in the main arm folding apparatus.

Internal preloading reduces impact of gravitation thus making behavior of the robotic arm more defined and predictable. A dual arm folding apparatus not only provides means to control arm's stiffness but also defines the overall shape of the arm and the way of its folding. (Timing sequence of sections movements).

### Coordination of Movements by Means of a Planetary Gear System

A coordinated operation of both said drive means can be achieved via programmable means, such as Computer Numerical Control (CNC) system. However more practical is to link both apparatuses with a planetary gear system which allows mechanical summarization of movements.

At the diagram of FIG. 7 said drive pivots 17 and 27 are not linked directly and thus independent. However in some practical implementations both drive pivots 17 and 27 might share a common worm drive. The internal preloading could be materialized via planetary transmission.

According to Examiner recommendations, description of the planetary gear system (all paragraphs below up to the Claims) has been withdrawn.

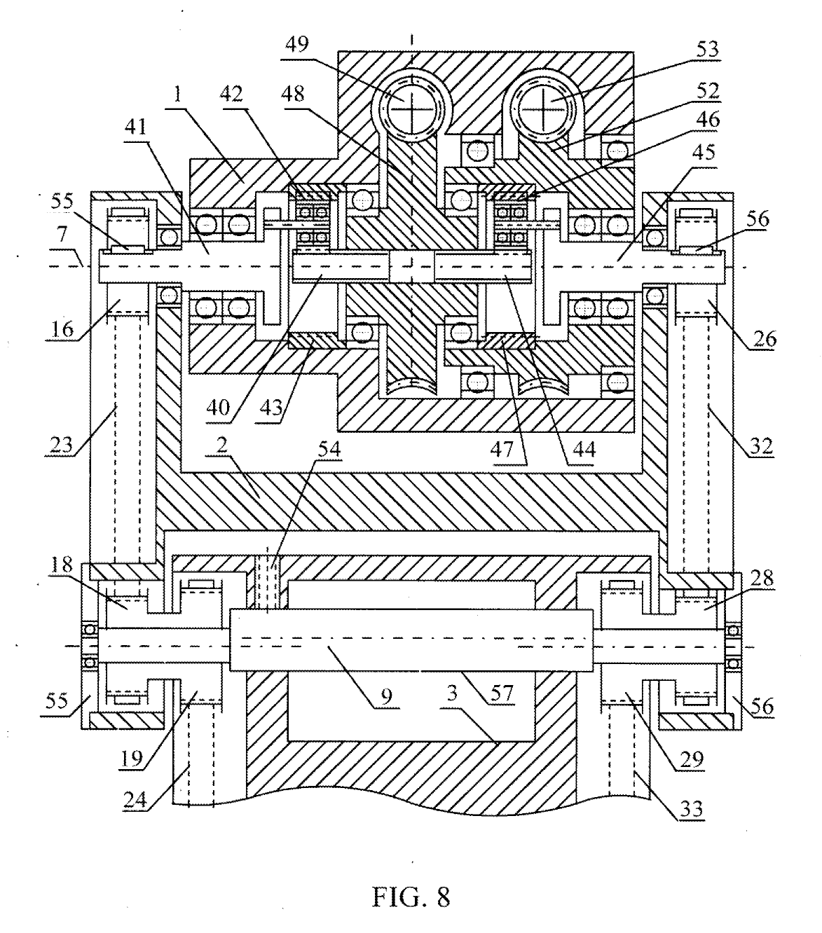

FIG. 8 shows a sectional view of a combined planetary drive mechanism implementing such coordination. For simplification only first two sections 2 and 3 are shown, all insignificant parts (like retaining clips, pins, screws etc.) have been omitted.

A drive mechanism for rotating said first and second drive pivots incorporates the first and second planetary gear sets.

The first planetary gear set is mounted coaxially with said shoulder pivot 7 and comprises a first sun gear 40, a first planet carrier 41 and supporting planet pinions 42 for rotation about said first sun gear 40 in meshed relation thereto, and internally toothed first annulus 43 fixed to said base 1 concentrically with said first sun gear 40 and meshed with said planet pinions 42. Said first planet carrier 41 is in fact a materialized embodiment of said first drive pivot 17 shown at FIG. 7.

The second planetary gear set mounted coaxially with said shoulder pivot 7 and comprising a second sun gear 44, a second planet carrier 45 (a materialized embodiment of said second drive pivot 27 shown at FIG. 7) and supporting planet pinions 46 for rotation about said second sun gear 44 in meshed relation thereto, and internally toothed second annulus 47 concentric with said second sun gear 44 and meshed with said planet pinions 46.

A first worm gear set comprising a first worm gear 48 mounted coaxially with said shoulder pivot 7 and fixed to both said first and second sun gears 40 and 44, and a first worm 49 driven by a first rotary drive means (not shown).

A second worm gear set comprising a second worm gear 52 mounted coaxially with said shoulder pivot 7 and fixed to said second annulus 47, and second worm 53 driven by a second rotary drive means (not shown).

The lead sprockets 16 and 26 are fixed to said satellite carriers 41 and 45 via keys 55 and 56.

Said slave sprocket 18 is fixed to said lead sprocket 19 (in this particular implementation they are fabricated as one rotary unit with two gear crowns, rotatably mounted on the elbow pivot 9). Similarly said slave sprocket 28 is fixed to lead sprocket 29 and also rotatably mounted on the elbow pivot 9.

### Belt Adjustment

Said elbow pivot 9 implements an elbow joint linking together said section 1 and section 2. It is rotatably mounted on said section 1 via eccentric flanges 55 and 56. Synchronous rotation of said flanges changes distance between pivots 7 and 9 thus providing means to adjust tension of said belts 23 and 32. At the same time said elbow pivot 9 is rotatably mounted on said section 3. The mounting cylinder surface 57 of said elbow pivot 9 is also maid eccentric, so rotation of said elbow pivot 9 changes the distance between said elbow pivot 9 and said wrist pivot 12 (shown at FIG. 7) thus providing means to adjust tension of said belts 24 and 33. After accomplishment of belt adjustment the lock screw 54 fixes said elbow pivot 9 to said section 3.

Although said worm 53 at FIG. 8 looks similar to said worm 51 at FIG. 7, in the particular implementation shown at FIG. 8 said worm 53 performs internal preloading only, does not participate in folding of the arm and thus not shown at FIG. 7. The main function of both planetary reducers is summarization of movements. Thus they too are not shown at FIG. 7.

### Operation of the Planetary Gear System

Initially, while said first worm 49 is still immovable, said second worm 53 performs a limited rotation until all slacks in both main and supplemental arm folding apparatuses are completely eliminated. An additional discrete rotation of said worm 53 will create the internal preloading proportional to the degree of this rotation. After that initial phase said worm 53 does not participate in the arm folding process—unless it is necessary to alternate the arm's stiffness.

Pivoting of said first worm 49 by a rotary motor (not shown) causes appropriate pivoting of said worm gear 48 and sun gears 40 and 44. That leads to synchronous pivoting of both lead sprockets 16 and 26 via satellite carriers 41 and 45. All further movements go exactly as has been described above for a dual arm folding apparatus (FIG. 7, FIG. 9 and FIG. 10).

What is claimed is:

1. A robot arm or the like, comprising:
A. A base;
B. An upper section having a first end and a second end, wherein the first end of the said upper section is rotatably secured to said base by a shoulder pivot to define a shoulder joint;
C. A middle section having a first end and a second end, wherein the first end of said middle section is secured to the second end of the said upper section by an elbow pivot to define an elbow joint;
D. A lower section having a first end and a second end, wherein the first end of said lower section is secured to the second end of said middle section by a wrist pivot to define a wrist joint;
E. A final section having a first end and a fingernail, wherein the first end of said final section is secured to the second end of said lower section by a final pivot to define a finger joint;
F. A main arm folding apparatus comprising:
i. An upper timing linkage having a first sprocket which is rotatably secured to said base by first drive pivot coaxial with said shoulder pivot, a second sprocket mounted in coaxial relation to said elbow pivot and freely rotatable with respect to said upper and lower sections;
ii. A middle timing linkage having a third sprocket which is rotatably secured to said shoulder pivot while being fixed to said second sprocket of said upper linkage, a fourth sprocket rotatably secured to said wrist pivot;
iii. A lower timing linkage having a fifth sprocket which is rotatably secured to said wrist pivot while being fixed to said fourth sprocket of said middle linkage, a final sprocket mounted in coaxial relation to said final pivot and fixed to final section;
iv. An upper drive chain operatively connecting said first and second sprockets;
v. A middle drive chain operatively connecting said third and forth sprockets;
vi. A lower drive chain operatively connecting said fifth and final sprockets;
vii. Main drive means for folding and unfolding said arm by rotating said first drive pivot relative to said shoulder pivot;

2. The robot arm of claim 1, wherein the supplementary arm folding apparatus, linking said final section with the supplementary drive pivot coaxial with said shoulder pivot, is being integrated;

3. The robot arm of claim 2, wherein said supplementary arm folding apparatus is identical to said main arm folding apparatus while the first sprocket of said supplementary apparatus is being fixed to said supplementary drive pivot, the final sprocket is being fixed to said final pivot, and all other sprockets share the same pivots of said main folding apparatus respectfully;

4. The robot arm of claim 2, wherein each section incorporates a mechanism for regulating the distance between its first and second end;

5 A drive mechanism for rotating said main and supplemental drive pivots, comprising:
A. A first planetary gear set mounted coaxially with said shoulder pivot and comprising a first sun gear, a first planet carrier fixed to said main drive pivot and supporting planet pinions for rotation about said first sun gear in meshed relation thereto, and internally toothed first annulus concentric with said first sun gear and meshed with said planet pinions;
B. A second planetary gear set mounted coaxially with said shoulder pivot and comprising a second sun gear, a second planet carrier fixed to said supplemental drive pivot and supporting planet pinions for rotation about said sun gear in meshed relation thereto, and internally toothed second annulus concentric with said sun gear and meshed with said planet pinions;
C. A first worm gear set comprising a first worm gear mounted coaxially with said shoulder pivot and fixed to both said first and second sun gears, and a first drive worm;
D. A second worm gear set comprising a second worm gear mounted coaxially with said shoulder pivot and fixed to said second annulus, and second drive worm;

6. A robot arm of claim 1, wherein all the timing linkages are implemented by belt-and-pulley linkages, comprising timing pulleys and timing belts;

7. A robot arm of claim 1, wherein all the timing linkages are implemented by gears, while all lead and slave gears belonging to the same section are linked together via a parasite gear;
